(19) United States
(12) Patent Application Publication
(10) Pub. No.: US 2006/0037659 A1
(43) Pub. Date: Feb. 23, 2006

(54) Inflatable pipe test probe

(76) Inventor: Terence Dominic Gillam, Queenland (AU)

Correspondence Address: SHELDON & MAK, INC, 225 SOUTH LAKE AVENUE, 9TH FLOOR, PASADENA, CA, 91101, US

(21) Appl. No.: 10/530,282

(22) PCT Filed: Sep. 4, 2003
(86) PCT No.: PCT/AU03/01143

§ 371 Date: Apr. 4, 2005

(30) Foreign Application Priority Data
Sep. 4, 2002 (AU) 2002951189

(51) Int. Cl. F16L 55/18; F16L 55/00; F16L 9/18; F16L 11/00

(52) U.S. Cl. 138/97; 138/104; 138/113; 138/116

(57) ABSTRACT

A probe (10) may be used to test or patch pipes where an operator (11) manually feeds the probe (10) along a pipe (12) by reason of an air tube (13) and CCTV cable (14). The operator may view via screen (16) the output from camera head (15) on the probe (10). The camera views the interior of a pipe in the direction of feed. The probe (10) has an elongate flexible body (16) so that it may deform to pass around corners in the pipe and be inflated to seal or apply patches.

### FIELD OF THE INVENTION

THIS INVENTION relates to an inflatable pipe test probe suitable for hydrostatic testing of pipes for leaks and simultaneous interior examination of the pipe using a camera.

### SUMMARY OF THE INVENTION

In one broad aspect the present invention comprises a flexible probe for sealing a pipe or applying a patch, the probe comprising an inflatable bladder and camera assembled in series at a distal end of a cable and hose, the cable and hose being used to feed the probe down a pipe in a feed direction and retract the probe in the opposite direction, the inflatable bladder comprising an elongate annular bladder surrounding the cable with the camera at the head, the camera providing an advance view in the feed direction, the probe being flexible and able to pass down a pipe and deform to pass around corners in the pipe while carrying a tubular patch and upon inflation seal or patch the pipe. The inflatable bladder preferably comprises a cylindrical elastic bladder sealed airtight at opposite ends and being biassed to expand medially. The inflatable bladder preferably has spaced sealing ribs distributed along its length. Different bladders are designed to suit different pipe sizes and to increase the life of the bladder is in use inflated to a predetermined pressure and size at that pressure. Thus it is preferable that a bladder is designed to suit a particular pipe size and in use is inflated to a predetermined pressure and size at that pressure so that its operation within the pipe is predictable and to specification.

In a preferred aspect the present invention resides in a pipe test probe comprising an inflatable seal and camera assembled in series at a distal end of a cable and hose used to feed the probe down a pipe in a feed direction and retract the probe in the opposite direction, the inflatable seal comprising an elongate annular bladder surrounding the cable with the camera at the head and providing an advance view in the feed direction, the probe being flexible and able to pass down a pipe and deform to pass around corners in the pipe and upon inflation to seal the pipe for static test purposes.

Typically the inflatable seal comprises a cylindrical elastic bladder sealed airtight at opposite ends and being biassed to expand medially by reason of medially thinned wall section or sections. Preferably the wall has protruding sealing ribs distributed along its length. The sealing ribs are preferably evenly spaced.

Preferably the bladder is designed to suit different pipe sizes and to increase the life of the bladder is in use inflated to a predetermined pressure and size at that pressure. In one form suited to a 100 mm pipe, the bladder has a 40 mm outside diameter in its relaxed state and is inflatable to 114 mm at a maximum pressure of between 10 psi to 15 psi. In the case of 150 mm pipe, the outside diameter would be 60 mm typically and 164 mm outside diameter when inflated to the 10 psi to 15 psi pressure. Any suitable elastic material may be used, particularly those materials suitable to repeated inflation and deflation in a hydrostatic pipe testing environment.

In another aspect there is provided a probe for remote patching of damaged pipes, the probe comprising an inflatable patch applicator and camera assembled in series at a distal end of a cable and hose used to feed the probe down a pipe in a feed direction and retract the probe in the opposite direction, the inflatable patch applicator comprising an elongate annular bladder surrounding the cable with the camera at the head, the camera providing an advance view in the feed direction, a tubular open ended adhesive patch surrounding the bladder and upon inflation of the bladder in situ to a predetermined pressure the bladder applies the patch and bulges out the open ends of the patch to dress the ends of the patch.

In another aspect there is provided a system for in situ remote patching of pipes, the system comprising an adhesive applicator jig for onsite application of adhesive to a tubular patch mounted on a flexible inflatable patch applicator probe located at the distal end of a flexible feed cable, the jig comprising a hollow former sandwiched between the probe and patch to stabilise same while the adhesive is being applied and then being slidably removable before the patch and probe are fed into a pipe.

### BRIEF DESCRIPTION OF THE DRAWINGS

In order that the present invention may be more readily understood and put into practical effect, reference will now be made to the accompanying drawings which illustrate one preferred embodiment of the invention as suited to 100 mm pipe testing.

FIG. 1 a schematic drawing illustrating the probe being used;

FIG. 2 is a part cut away view illustrating the probe in position in a pipe prior to inflation; and

FIG. 3 is a drawing illustrating the probe in position, inflated and sealing the pipe.

FIG. 4 is a drawing illustrating a jig for loading a probe with a resin saturated patch;

FIGS. and 5 and 6 demonstrate the process by which the patch is loaded onto an inflatable probe; and

FIGS. 7 to 10 illustrate the use of the probe to apply the patch, the broken pipe break having being located either using the video camera or using the static test procedure.

### METHOD OF PERFORMANCE

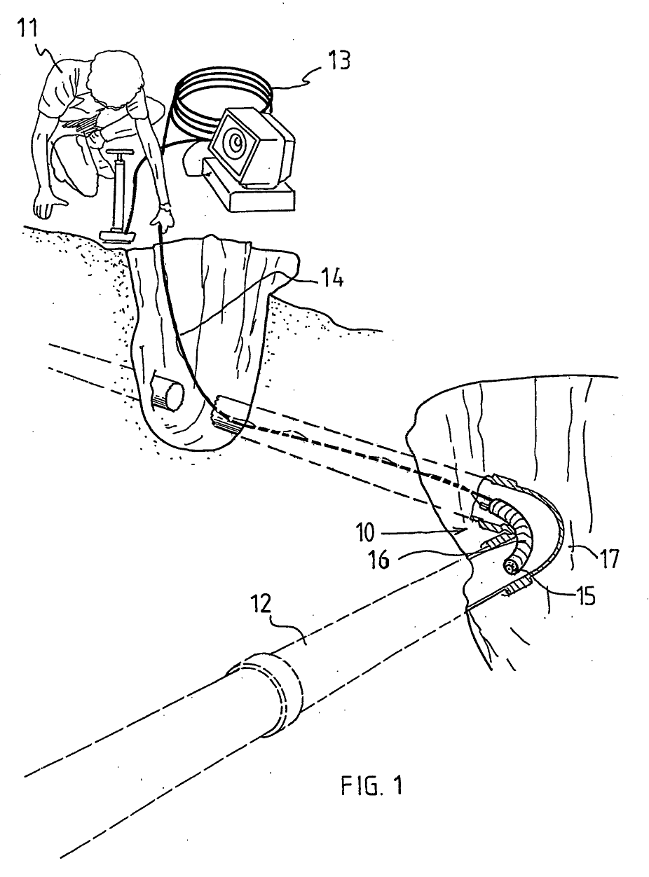

Referring to the drawings and initially to FIG. 1, there is illustrated a test probe 10 according to the invention where an operator 11 manually feeds the probe 10 along a pipe 12 by reason of an air tube 13 and CCTV cable 14. The operator may view the output from camera head 15 on the probe 10 via video monitor 16. As can be seen in FIG. 1, the probe 10 has a elongate flexible body 16 so that it may deform to pass around corners in the pipe 12 as typically illustrated at 17. This construction of the probe will be described in greater detail in relation to the drawings.

In order to test the pipe 12, the probe 10 is positioned at a desired position in the pipe 12 and inflated to perform a static test by back filling the pipe 12 from the probe and progressively testing for leakage by stepwise inflation and deflation of the probe 10 as it is withdrawn using normal hydrostatic test procedures.

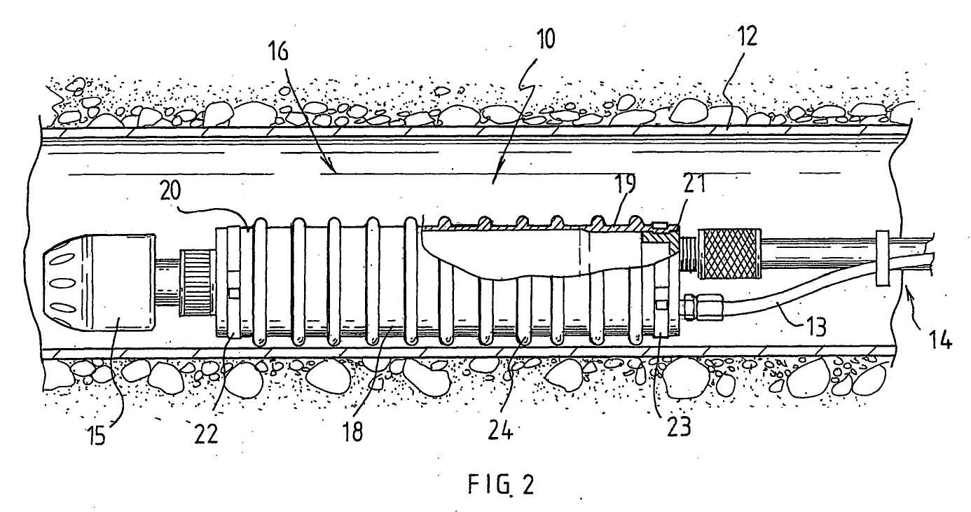

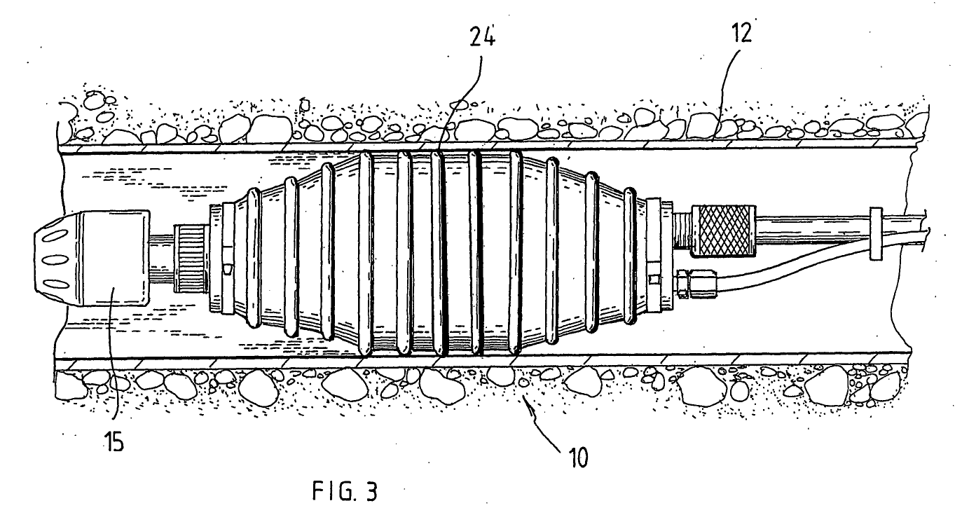

Referring now to FIGS. 2 and 3, the probe 10 is illustrated in greater detail and like numerals have been used to illustrate like features. The probe 10 comprises the camera head 15 and elongate body 16 which comprises in this case an elastic bladder 18 designed for testing 100 mm pipe. The size will vary for different pipe sizes. The bladder 18 has thickened marginal edge portions 19 and 20 at opposite ends so that when inflated it preferentially expands medially as shown in FIG. 3. At opposite ends of the bladder, stainless steel rigid couplings 21 and 22 rigidly secure the fittings for the camera head 15 and the cable 14 and air tube 13 to the bladder 18 by clamping rings 22 and 23 respectively. The bladder has sealing ridges 24 distributed evenly along its length.

In the illustrated embodiment the bladder 18 has an uninflated outside diameter of 40 mm and may be expanded to a designed external diameter of 114 mm at 10 psi to 15 psi inflation pressure. This would effectively seal the 100 mm pipe in use.

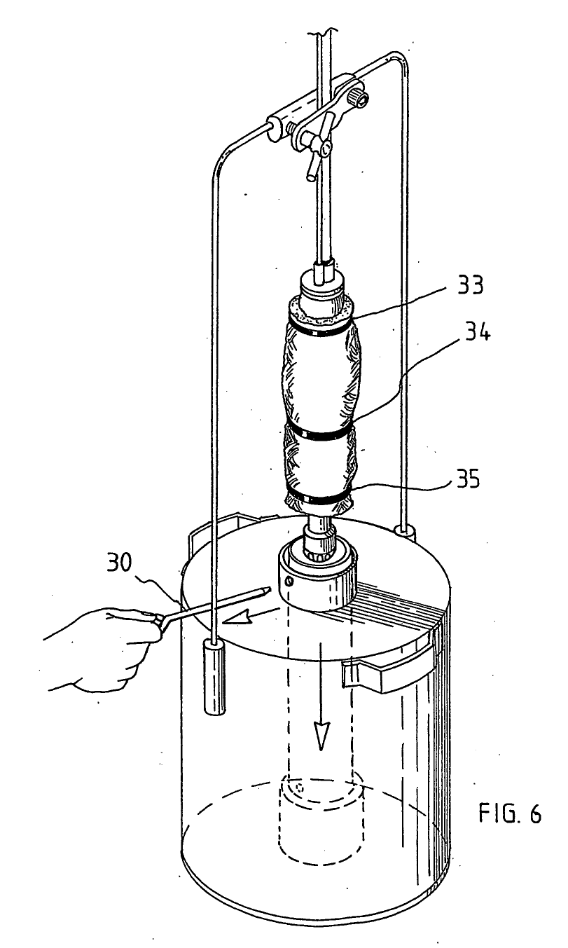

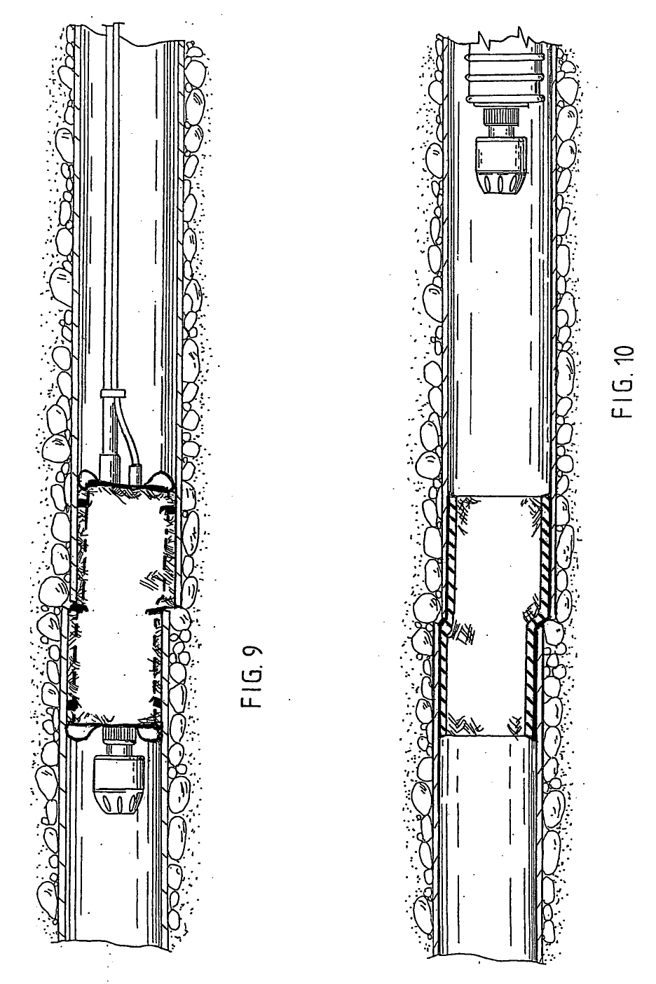

Once a break has been located, a probe of the present type may be utilised to apply a patch to the break referring to FIGS. 5 to 10 this aspect will be described. A resin saturated cylindrical patch is applied to the interior of a pipe using the expandable bladder to force the patch onto the interior wall of the pipe to affect the patch. The present illustrated embodiment a probe 550 mm long is utilised, the camera being used to view the break and then the probe being moved an additional 350 mm from the head of the camera to centre the patch on the break.

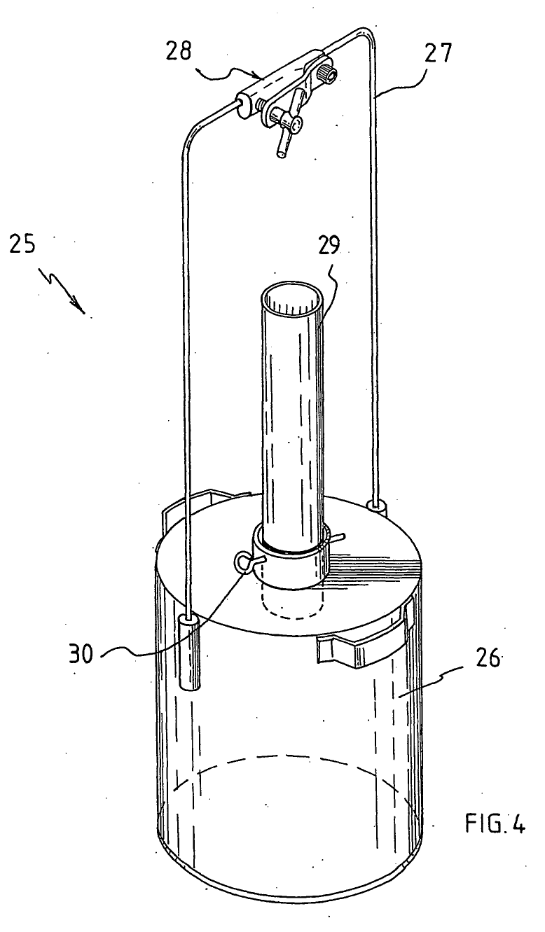

FIGS. 4, 5 and 6 illustrate a process whereby resin may be applied to the patch. The patch may be of any suitable type utilised and commonly applied to the lining pipes cut to appropriate length and the resin being applied on site, any suitable resin for plumbing applications may be used, typically two part apoxy/polyamines suited to a plumbing environment may be utilised and for under water application. It is preferable that it be low viscosity and there be a relatively short curing time, typically touch dry in two hours at 25° C. and hard at 12 hours at 25° C. The base is typically an epoxy resin liquid polymer base at 40-70%, the cure being Aminated Oligomer 20-50%. A suitable product is available from NMP, Unit 1910 Miltiadis St, Acacia Ridge, Qld Australia (www.nmp-pty.com.au). As can be seem from FIG. 4 the jig 25 includes a drum section 26, a hanger 27, a clamp 28, a former tube 29 and a release pin 30. The release pin 30 enables the former tube 29 to drop into the drum, the former tube 29 is sized to enable a probe 31 to be positioned in the former tube with the patch material fastened to the probe by a rubber band 33 positioned just above the upper edge of the former tube 29 as illustrated in FIG. 5. The resin mix is applied to the patch material while it is on the former to saturate the patch and after the former is dropped into the drum 26 the rubber bands 34 and 35 are positioned as illustrated in FIG. 6. It will be. appreciated that the patch tube material 32 includes an internal polyurethane lining so that the resin does not come into contact with the probe. A suitable patch material is Brawoliner available from RS TECHNIK AG werkstrasse 9 CH 8627 Gruningen (www.rstechnik.com) As a matter of process a release agent of any suitable type may be sprayed onto the probe before the resin is applied. Once the resin mix is applied and just prior to entry into the pipe to be repaired each of the rubber bands 33, 34, and 35 are cut part way through so that the rubber bands will break as the probe expands to force the patch material into engagement with the pipe.

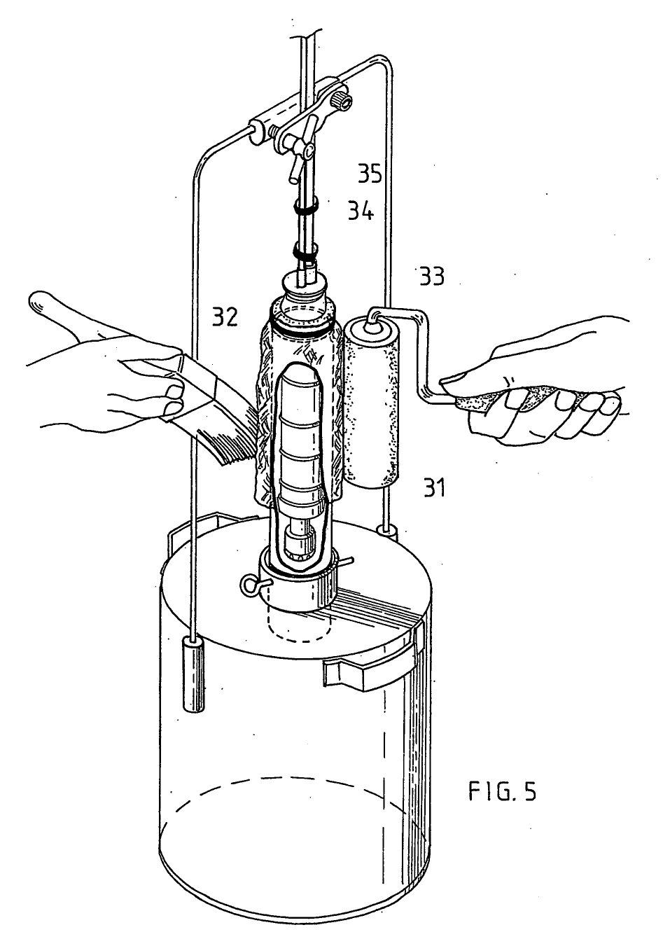

FIGS. 7, 8, 9 and 10 illustrate the application of the patch, the breaking of the rubber bands and the removal of the probe with the patch in place.

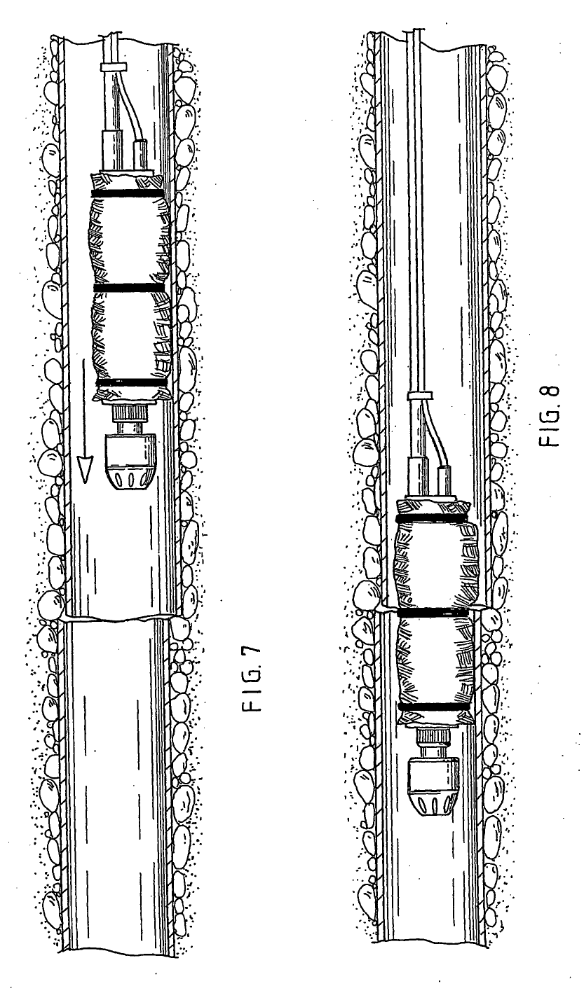

In the present case, the probe length is selected to suit the pipe size and length of break. The probe expands the same way as the test probe but the applied pressure and the configuration is different. The probe is medially thin so that it expands centrally and in the illustrated embodiment, the applicant drives the probe to 20 psi and this has the effect of initially driving the patch in its medial region into contact with the pipe and then as the probe further expands it will fill the entire pipe and will bulge at each end as illustrated in FIG. 9. this annular bulging is to dress the edge of the patch to provide a small taper by reason of the probe bulging in the longitudinal direction beyond the opposite ends of the patch.

Whilst the above has been given by way of illustrative example of the present invention, many variations and modifications thereto will be apparent to those skilled in the art without departing from the broad ambit and scope of the invention as herein set out in the appended claims.

1. A flexible probe for sealing a pipe or applying a patch, the probe comprising an inflatable bladder and camera assembled in series at a distal end of a cable and hose, the cable and hose being used to feed the probe down a pipe in a feed direction and retract the probe in the opposite direction, the inflatable bladder comprising an elongate annular bladder surrounding the cable with the camera at the head, the camera providing an advance view in the feed direction, the probe being flexible and able to pass down a pipe and deform to pass around corners in the pipe while carrying a tubular patch and upon inflation seal or patch the pipe.

2. A probe according to claim 1 wherein the inflatable bladder comprises a cylindrical elastic bladder sealed airtight at opposite ends and being biassed to expand medially.

3. A probe according to claim 1 wherein the inflatable bladder has spaced sealing ribs distributed along its length.

4. A probe according to claim 1 wherein the bladder is designed to suit a particular pipe size and in use is inflated to a predetermined pressure and size at that pressure.

5. A probe according to claim 1 wherein the inflatable bladder comprises a cylindrical elastic bladder sealed airtight at opposite ends and being biassed to expand medially, the inflatable bladder having spaced sealing ribs distributed along its length.

6. A probe according to claim 1 wherein the inflatable bladder comprises a cylindrical elastic bladder sealed airtight at opposite ends and being biassed to expand medially, the bladder being designed to suit a particular pipe size and in use is inflated to a predetermined pressure and size at that pressure.

7. A probe according to claim 1 wherein the inflatable bladder has spaced sealing ribs distributed along its length, the bladder being designed to suit a particular pipe size and in use is inflated to a predetermined pressure and size at that pressure.

8. A pipe test probe comprising an inflatable seal and camera assembled in series at a distal end of a cable and hose used to feed the probe down a pipe in a feed direction and retract the probe in the opposite direction, the inflatable seal comprising an elongate annular bladder surrounding the cable with the camera at the head and providing an advance view in the feed direction, the probe being flexible and able to pass down a pipe and deform to pass around corners in the pipe and upon inflation to seal the pipe for static test purposes.

9. A probe according to claim 8 wherein the inflatable bladder comprises a cylindrical elastic bladder sealed airtight at opposite ends and being biassed to expand medially.

10. A probe according to claim 8 wherein the inflatable bladder has spaced sealing ribs distributed along its length.

11. A probe according to claim 8 wherein the bladder is designed to suit a particular pipe size and in use is inflated to a predetermined pressure and size at that pressure.

12. A probe according to claim 8 wherein the inflatable bladder comprises a cylindrical elastic bladder sealed airtight at opposite ends and being biassed to expand medially, the inflatable bladder having spaced sealing ribs distributed along its length.

13. A probe according to claim 8 wherein the inflatable bladder comprises a cylindrical elastic bladder sealed airtight at opposite ends and being biassed to expand medially, the bladder being designed to suit a particular pipe size and in use is inflated to a predetermined pressure and size at that pressure.

14. A probe according to claim 8 wherein the inflatable bladder has spaced sealing ribs distributed along its length, the bladder being designed to suit a particular pipe size and in use is inflated to a predetermined pressure and size at that pressure.

15. A patch applicator probe for remote patching of damaged pipes, the probe comprising an inflatable patch applicator and camera assembled in series at a distal end of a cable and hose used to feed the probe down a pipe in a feed direction and retract the probe in the opposite direction, the inflatable patch applicator comprising an elongate annular bladder surrounding the cable with the camera at the head, the camera providing an advance view in the feed direction, a tubular open ended adhesive patch surrounding the bladder and upon inflation of the bladder in situ to a predetermined pressure the bladder applies the patch and bulges out the open ends of the patch to dress the ends of the patch.

16. A probe according to claim 15 wherein the inflatable bladder comprises a cylindrical elastic bladder sealed airtight at opposite ends and being biassed to expand medially.

17. A probe according to claim 15 wherein the inflatable bladder has spaced sealing ribs distributed along its length.

18. A probe according to claim 15 wherein the bladder is designed to suit a particular pipe size and in use is inflated to a predetermined pressure and size at that pressure.

19. A probe according to claim 15 wherein the inflatable bladder comprises a cylindrical elastic bladder sealed airtight at opposite ends and being biassed to expand medially, the inflatable bladder having spaced sealing ribs distributed along its length.

20. A probe according to claim 15 wherein the inflatable bladder comprises a cylindrical elastic bladder sealed airtight at opposite ends and being biassed to expand medially, the bladder being designed to suit a particular pipe size and in use is inflated to a predetermined pressure and size at that pressure.

21. A probe according to claim 15 wherein the inflatable bladder has spaced sealing ribs distributed along its length, the bladder being designed to suit a particular pipe size and in use is inflated to a predetermined pressure and size at that pressure.

22. A system for in situ remote patching of pipes, the system comprising a flexible inflatable patch applicator probe and an adhesive applicator jig for onsite application of adhesive to the probe, the probe having a inflatable bladder and camera located at the distal end of a flexible feed cable, the jig comprising a hollow former sandwiched between the probe and patch to stabilise same while the adhesive is being applied and then being slidably removable before the patch and probe are fed into a pipe.

23. A system according to claim 22 wherein the inflatable bladder comprises a cylindrical elastic bladder sealed airtight at opposite ends and being biassed to expand medially.

24. A system according to claim 22 wherein the inflatable bladder has spaced sealing ribs distributed along its length.

25. A system according to claim 22 wherein the bladder is designed to suit a particular pipe size and in use is inflated to a predetermined pressure and size at that pressure.

26. A system according to claim 22 wherein the inflatable bladder comprises a cylindrical elastic bladder sealed airtight at opposite ends and being biassed to expand medially, the inflatable bladder having spaced sealing ribs distributed along its length.

27. A system according to claim 22 wherein the inflatable bladder comprises a cylindrical elastic bladder sealed airtight at opposite ends and being biassed to expand medially, the bladder being designed to suit a particular pipe size and in use is inflated to a predetermined pressure and size at that pressure.

28. A system according to claim 22 wherein the inflatable bladder has spaced sealing ribs distributed along its length, the bladder being designed to suit a particular pipe size and in use is inflated to a predetermined pressure and size at that pressure.
